(19) United States
(12) Patent Application Publication
(10) Pub. No.: US 2025/0049283 A1
(43) Pub. Date: Feb. 13, 2025

(54) MOPPING BEHAVIOR CONTROL OF MOBILE CLEANING ROBOT

(71) Applicant: iRobot Corporation, Bedford, MA (US)

(72) Inventors: Shiwei Wang, Nashua, NH (US); Jonathan J. Dorich, Billerica, MA (US); Jennifer Smith, Beverly, MA (US); Lauren D. Stern, Wakefield, MA (US); Dan Wivagg, Westford, MA (US); Whitney Crooks, Cambridge, MA (US); Sebastian Jakymiw, Washington, DC (US); Prajakta Shyamkant Dhamorikar, Medford, MA (US); Brianna White, Madison, MS (US)

(21) Appl. No.: 18/231,919

(22) Filed: Aug. 9, 2023

(51) Int. Cl. A47L 11/40

(52) U.S. Cl. CPC A47L 11/4011; A47L 11/4072; A47L 11/4088; A47L 2201/04; A47L 2201/06

(57) ABSTRACT

A method of operating a mobile cleaning robot can include engaging a flooring surface of an environment with a cleaning pad of the mobile cleaning robot. At least one wheel of the mobile cleaning robot can be operated to move the mobile cleaning robot forward relative to the flooring surface a first time along a cleaning rank while the cleaning pad is engaged with the flooring surface. After moving forward, at least one wheel can be operated to move the mobile cleaning robot rearward relative to the flooring surface along the cleaning rank while the cleaning pad is engaged with the flooring surface. After moving rearward, at least one wheel can be operated to move the mobile cleaning robot forward a second time relative to the flooring surface along the cleaning rank while the cleaning pad is engaged with the flooring surface.

### BACKGROUND

Autonomous mobile robots can move about an environment and can perform functions and operations in a variety of categories, including but not limited to security operations, infrastructure or maintenance operations, navigation or mapping operations, inventory management operations, and robot/human interaction operations. Some mobile robots, known as cleaning robots, can perform cleaning tasks autonomously within an environment, e.g., a home. Many kinds of cleaning robots are autonomous to some degree and in different ways. For example, some mobile cleaning robots can perform automated mopping operations or routines.

### SUMMARY

A mobile cleaning robot can be an autonomous robot that is at least partially controlled locally (e.g. via controls on the robot) or remotely (e.g. via a remote handheld device) to move about an environment. One or more processors within the mobile cleaning robot can control movement of the robot within the environment as well as various routines such as cleaning routines or portions thereof. Mobile cleaning robots that include a mopping pad can be designed to perform wet or dry mopping of a surface. However, depending on the environment, multiple cleaning passes may be needed to completely clean a flooring surface.

The devices, systems, or methods of this application can help to address this issue by including a processor configured move a mobile cleaning robot about an environment in such a way that mopping or cleaning efficiency is increased in a single pass versus moving of the robot in a straight line. For example, the processor can control the mobile cleaning robot to move in a back-and-forth pattern along a single cleaning line or cleaning rank such that the robot passes over each surface several times before moving forward. The processor or controller can also operate a cleaning pad assembly of the mobile cleaning robot to move back-and-forth relative to a body of the robot as the robot moves relative to the flooring surface. Such devices and methods can help to perform a more efficient or effective mopping or cleaning process, mission, or routine.

In one example, a method of operating a mobile cleaning robot can include engaging a flooring surface of an environment with a cleaning pad of the mobile cleaning robot. At least one wheel of the mobile cleaning robot can be operated to move the mobile cleaning robot forward relative to the flooring surface a first time along a cleaning rank while the cleaning pad is engaged with the flooring surface. After moving forward, at least one wheel can be operated to move the mobile cleaning robot rearward relative to the flooring surface along the cleaning rank while the cleaning pad is engaged with the flooring surface. After moving rearward, at least one wheel can be operated to move the mobile cleaning robot forward a second time relative to the flooring surface along the cleaning rank while the cleaning pad is engaged with the flooring surface.

The above discussion is intended to provide an overview of subject matter of the present patent application. It is not intended to provide an exclusive or exhaustive explanation of the invention. The description below is included to provide further information about the present patent application.

### BRIEF DESCRIPTION OF THE DRAWINGS

Various embodiments are illustrated by way of example in the figures of the accompanying drawings. Such embodiments are demonstrative and not intended to be exhaustive or exclusive embodiments of the present subject matter.

FIG. 1 illustrates a plan view of a mobile cleaning robot in an environment.

FIG. 2A illustrates an isometric view of a mobile cleaning robot in a first condition.

FIG. 2B illustrates an isometric view of a mobile cleaning robot in a second condition.

FIG. 2C illustrates an isometric view of a mobile cleaning robot in a third condition.

FIG. 2D illustrates a bottom view of a mobile cleaning robot in a third condition.

FIG. 2E illustrates a top isometric view of a mobile cleaning robot in a third condition.

FIG. 2F illustrates a side cross-sectional view of a mobile cleaning robot in a first condition.

FIG. 3 illustrates a diagram illustrating an example of a communication network in which a mobile cleaning robot operates and data transmission in the network.

FIG. 4 illustrates a schematic of a movement path of a mobile cleaning robot through a portion of an environment.

FIG. 5 illustrates a schematic of a movement path of a mobile cleaning robot through a portion of an environment.

FIG. 6 illustrates a schematic of a movement path of a mobile cleaning robot through a portion of an environment.

FIG. 7 illustrates a schematic of a movement path of a mobile cleaning robot through a portion of an environment.

FIG. 8 illustrates a block diagram illustrating an example of a machine upon which one or more embodiments may be implemented.

### DETAILED DESCRIPTION

### Robot Operation Summary

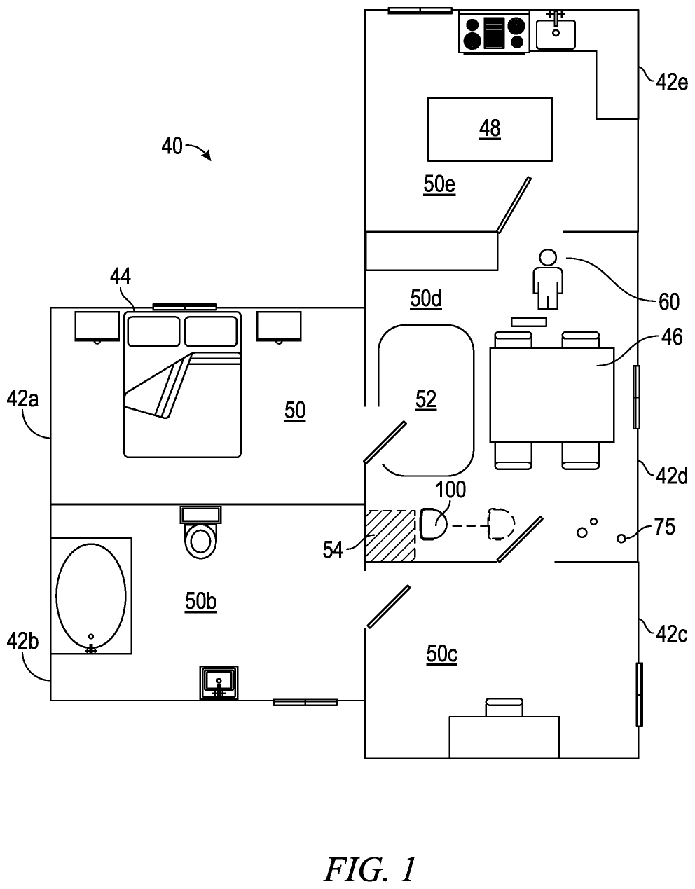

FIG. 1 illustrates a plan view of a mobile cleaning robot 100 in an environment 40, in accordance with at least one example of this disclosure. The environment 40 can be a dwelling, such as a home or an apartment, and can include rooms 42a-42e. Obstacles, such as a bed 44, a table 46, and an island 48 can be located in the rooms 42 of the environment. Each of the rooms 42a-42e can have a floor surface 50a-50e, respectively. Some rooms, such as the room 42d, can include a rug, such as a rug 52. The floor surfaces 50 can be of one or more types such as hardwood, ceramic, low-pile carpet, medium-pile carpet, long (or high)-pile carpet, stone, or the like.

The mobile cleaning robot 100 can be operated, such as by a user 60, to autonomously clean the environment 40 in a room-by-room fashion. In some examples, the robot 100 can clean the floor surface 50a of one room, such as the room 42a, before moving to the next room, such as the room 42d, to clean the surface of the room 42d. Different rooms can have different types of floor surfaces. For example, the room 42e (which can be a kitchen) can have a hard floor surface, such as wood or ceramic tile, and the room 42a (which can be a bedroom) can have a carpet surface, such as a medium pile carpet. Other rooms, such as the room 42d (which can be a dining room) can include multiple surfaces where the rug 52 is located within the room 42d.

During cleaning or traveling operations, the robot 100 can use data collected from various sensors (such as optical sensors) and calculations (such as odometry and obstacle detection) to develop a map of the environment 40. Once the map is created, the user 60 can define rooms or zones (such as the rooms 42) within the map. The map can be presentable to the user 60 on a user interface, such as a mobile device, where the user 60 can direct or change cleaning preferences, for example.

Also, during operation, the robot 100 can detect surface types within each of the rooms 42, which can be stored in the robot 100 or another device. The robot 100 can update the map (or data related thereto) such as to include or account for surface types of the floor surfaces 50a-50e of each of the respective rooms 42 of the environment 40. In some examples, the map can be updated to show the different surface types such as within each of the rooms 42.

In some examples, the user 60 can define a behavior control zone 54. In autonomous operation, the robot 100 can initiate a behavior in response to being in or near the behavior control zone 54. For example, the user 60 can define an area of the environment 40 that is prone to becoming dirty to be the behavior control zone 54. In response, the robot 100 can initiate a focused cleaning behavior in which the robot 100 performs a focused cleaning of a portion of the floor surface 50d in the behavior control zone 54.

### Robot Example

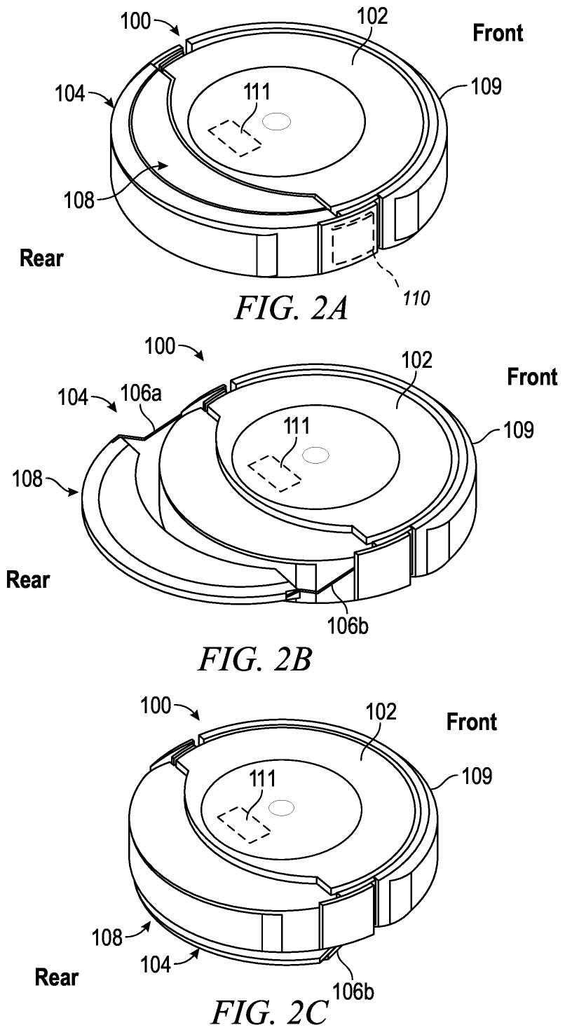

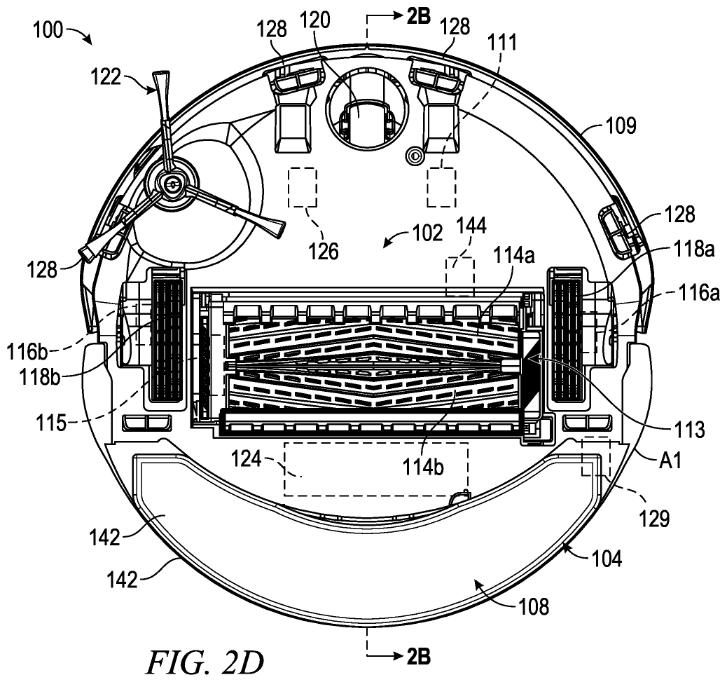

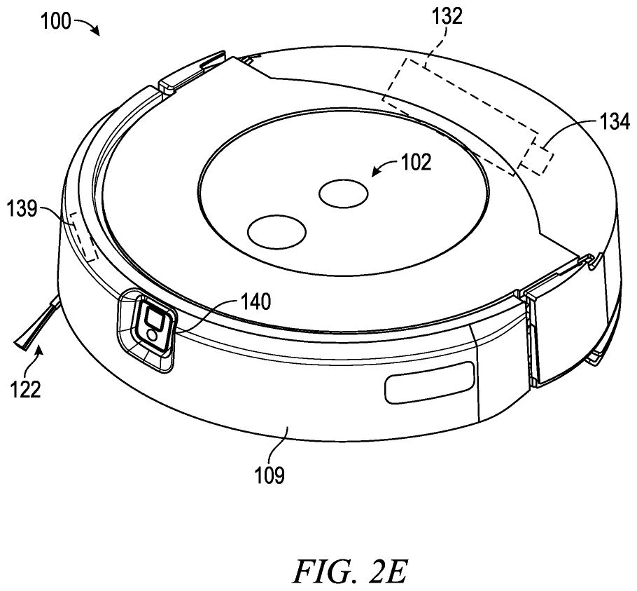

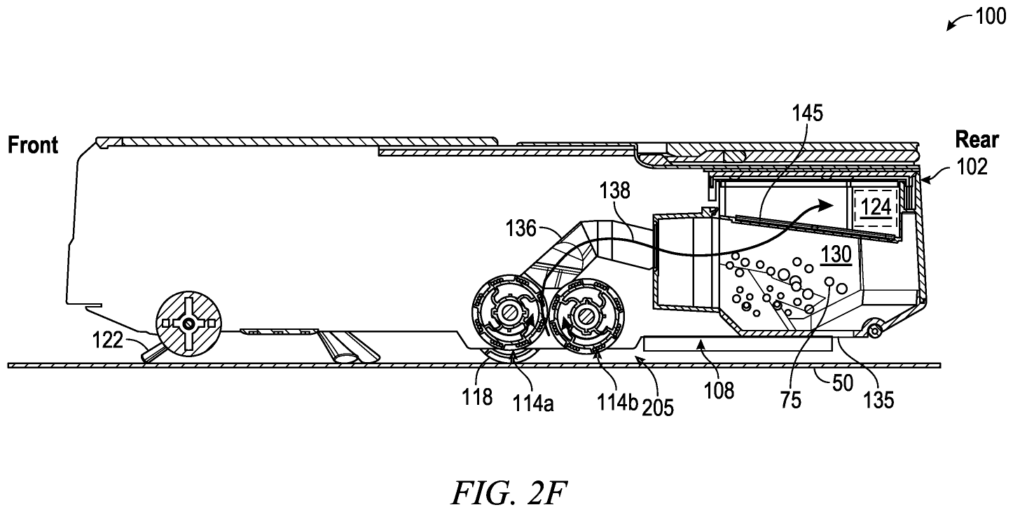

FIG. 2A illustrates an isometric view of a mobile cleaning robot 100 with a pad assembly in a stored position. FIG. 2B illustrates an isometric view of the mobile cleaning robot 100 with the pad assembly in an extended position. FIG. 2C illustrates an isometric view of the mobile cleaning robot 100 with the pad assembly in a mopping position. FIGS. 2A-2C also show orientation indicators Front and Rear. FIGS. 2A-2C are discussed together below.

The mobile cleaning robot 100 can include a body 102 and a mopping system 104. The mopping system 104 can include arms 106a and 106b (referred to together as arms 106) and a pad assembly 108. The robot 100 can also include a bumper 109 and other features such as an extractor (including rollers), one or more side brushes, a vacuum system, a controller, a drive system (e.g., motor, geartrain, and wheels), a caster, and sensors, as discussed in further detail below. A distal portion of the arms 106 can be connected to the pad assembly 108 and a proximal portion of the arms 106a and 106b can be connected to an internal drive system to drive the arms 106 to move the pad assembly 108.

FIGS. 2A-2C show how the robot 100 can be operated to move the pad assembly 108 from a stored position in FIG. 2A to a transition or partially deployed position in FIG. 2B, to a mopping or a deployed position in FIG. 2C. In the stored position of FIG. 2A, the robot 100 can perform only vacuuming operations. In the deployed position of FIG. 2C, the robot 100 can perform vacuuming operations or mopping operations. FIGS. 2D-2E discuss additional components of the robot 100.

### Components of the Robot

FIG. 2D illustrates a bottom view of the mobile cleaning robot 100 and FIG. 2E illustrates a top isometric view of the robot 100. FIGS. 2D and 2E are discussed together below. The robot 100 of FIGS. 2D and 2E can be consistent with FIGS. 2A-2C; FIGS. 2D-2E show additional details of the robot 100. For example, FIGS. 2D-2E show that the robot 100 can include a body 102, a bumper 109, an extractor 113 (including rollers 114a and 114b), motors 116a and 116b, drive wheels 118a and 118b, a caster 120, a side brush assembly 122, a vacuum assembly 124, memory 126, and sensors 128. The mopping system 104 can also include a tank 132 and a pump 134.

The cleaning robot 100 can be an autonomous cleaning robot that can autonomously traverse the floor surface 50 (of FIG. 1) while ingesting the debris from different parts of the floor surface 50. As shown in FIG. 2D, the robot 100 can include the body 102 that can be movable across the floor surface 50. The body 102 can include multiple connected structures to which movable or fixed components of the cleaning robot 100 are mounted. The connected structures can include, for example, an outer housing to cover internal components of the cleaning robot 100, a chassis to which the drive wheels 118a and 118b and the cleaning rollers 114a and 114b (of the cleaning assembly 113) are mounted, and the bumper 109 connected to the outer housing. The caster wheel 120 can support the front portion of the body 102 above the floor surface 50, and the drive wheels 118a and 118b can support the middle and rear portions of the body 102 (and can also support a majority of the weight of the robot 100) above the floor surface 50.

As shown in FIG. 2D, the body 102 can include a front portion that can have a substantially semicircular shape and that can be connected to the bumper 109. The body 102 can also include a rear portion that has a substantially semicircular shape. In other examples, the body 102 can have other shapes such as a square front or straight front. The robot 100 can also include a drive system including the actuators (e.g., motors) 116a and 116b. The actuators 116a and 116b can be connected to the body 102 and can be operably connected to the drive wheels 118a and 118b, which can be rotatably mounted to the body 102. The actuators 116a and 116b, when driven, can rotate the drive wheels 118a and 118b to enable the robot 100 to autonomously move across the floor surface 50.

The vacuum assembly 124 can be located at least partially within the body 102 of the robot 100, such as in a rear portion of the body 102, and the vacuum assembly 124 can be located in other locations in other examples. The vacuum assembly 124 can include a motor to drive an impeller to generate the airflow when rotated. The airflow from the vacuum assembly 124 and the cleaning rollers 114, when rotated, can cooperate to ingest the debris into the robot 100.

The cleaning bin 130 (shown in FIG. 2F) can be mounted in the body 102 and can contain the debris ingested by the robot 100. A filter in the body 102 can separate the debris from the airflow before the airflow enters the vacuum assembly 124 and is exhausted out of the body 102. In this regard, the debris can be captured in both the cleaning bin 130 and the filter before the airflow is exhausted from the body 102. In some examples, the vacuum assembly 124 and extractor 113 can be optionally included or can be of a different type. Optionally, the vacuum assembly 124 can be operated during mopping operations, such as those including the mopping system 104. That is, the robot 100 can perform simultaneous vacuuming and mopping missions or operations.

The cleaning rollers 114a and 114b can be operably connected to an actuator 115, e.g., a motor, through a gearbox. The cleaning head 113 and the cleaning rollers 114a and 114b can be located forward of the cleaning bin 130. The cleaning rollers 114 can be mounted or connected to an underside of the body 102 so that the cleaning rollers 114a and 114b can engage debris on the floor surface 50 during the cleaning operation when the underside of the body 102 faces the floor surface 50.

The controller 111 can be located at least partially within the housing 102 and can be a programmable controller, such as a single or multi-board computer, a direct digital controller (DDC), a programmable logic controller (PLC), or the like. In other examples, the controller 111 can be any computing device, such as a handheld computer, for example, a smart phone, a tablet, a laptop, a desktop computer, or any other computing device including a processor, memory, and communication capabilities. The memory 126 can be one or more types of memory, such as volatile or non-volatile memory, read-only memory (ROM), random-access memory (RAM), magnetic disk storage media, optical storage media, flash-memory devices, and other storage devices and media. The memory 126 can be located within the housing 102, can be connected to the controller 111, and can be accessible by the controller 111.

The controller 111 can operate the actuators 116a and 116b to autonomously navigate the robot 100 about the floor surface 50 during a cleaning operation. The actuators 116a and 116b can be operable to drive the robot 100 in a forward drive direction, in a backwards direction, and to turn the robot 100. The controller 111 can operate the vacuum assembly 124 to generate an airflow that flows through an air gap near the cleaning rollers 114, through the body 102, and out of the body 102.

The robot 100 can include a sensor system including one or more sensors. The sensor system, as described herein, can generate one or more signal indicative of a current location of the robot 100, and can generate signals indicative of locations of the robot 100 as the robot 100 travels along the floor surface 50. The sensors 128 (shown in FIG. 2A) can be located along a bottom portion of the housing 102. Each of the sensors 128 can be an optical sensor that can be configured to detect a presence or absence of an object below the optical sensor, such as the floor surface 50. The sensors 128 (optionally cliff sensors) can be connected to the controller 111 and can be used by the controller 111 to navigate the robot 100 within the environment 40. In some examples, the cliff sensors can be used to detect a floor surface type which the controller 111 can use to selectively operate the mopping system 104.

The cleaning pad assembly 108 can be a cleaning pad connected to the bottom portion of the body 102 (or connected to the actuator 110 that can be configured to move the assembly 108 between a stored position and a cleaning position), such as to the cleaning bin 130 in a location to the rear of the extractor 113. The tank 132 can be a water tank configured to store water or fluid, such as cleaning fluid, for delivery to a mopping pad 142. The pump 134 can be connected to the controller 111 and can be in fluid communication with the tank 132. The controller 111 can be configured to operate the pump 134 to deliver fluid to the mopping pad 142 during mopping operations. For example, fluid can be delivered through one or more dispensers 117 to the mopping pad 142. The dispenser(s) 117 can be a valve, opening, or the like and can be configured to deliver fluid to the floor surface 50 of the environment 40 or to the pad 142 directly. In some examples, the pad 142 can be a dry pad such as for dusting or dry debris removal. The pad 142 can also be any cloth, fabric, or the like configured for cleaning (either wet or dry) of a floor surface.

As shown in FIG. 2F, the vacuum assembly 124 can be located at least partially within the body 102 of the robot 100, e.g., in the rear portion of the body 102. The controller 111 can operate the vacuum assembly 124 to generate an airflow that flows through the air gap near the cleaning rollers 114, through the body 102, and out of the body 102. The airflow and the cleaning rollers 114, when rotated, can cooperate to ingest debris 75 into a suction duct 136 of the robot 100. The suction duct 136 can extend down to or near a bottom portion of the body 102 and can be at least partially defined by the cleaning assembly 113.

The suction duct 136 can be connected to the cleaning head 113 or cleaning assembly and can be connected to a cleaning bin 130. The cleaning bin 130 can be mounted in the body 102 and can contain the debris 75 ingested by the robot 100. A filter 145 can be located in the body 102, which can help to separate the debris 75 from the airflow before the airflow 138 enters the vacuum assembly 124 and is exhausted out of the body 102. In this regard, the debris 75 can be captured in both the cleaning bin 130 and the filter before the airflow 138 is exhausted from the body 102. The robot 100 can also include a debris port 135 that can extend at least partially through the body 102 or the cleaning bin 130 and can be operable to remove the debris 75 from the cleaning bin 130, such as via a docking station or evacuation station.

The cleaning rollers 114a and 114b can operably connected to one or more actuators 115, e.g., motors, respectively. The cleaning head 113 and the cleaning rollers 114a and 114b can be positioned forward of the cleaning bin 130. The cleaning rollers 114a and 114b can be mounted to a housing of the cleaning head 113 and mounted, e.g., indirectly or directly, to the body 102 of the robot 100. In particular, the cleaning rollers 114a and 114b can be mounted to an underside of the body 102 so that the cleaning rollers 114a and 114b engage debris 75 on the floor surface 50 during the cleaning operation when the underside faces the floor surface 50.

### Operation of the Robot

In operation of some examples, the controller 111 can be used to instruct the robot 100 to perform a mission. In such a case, the controller 111 can operate the motors 116 to drive the drive wheels 118 and propel the robot 100 along the floor surface 50. The robot 100 can be propelled in a forward drive direction or a rearward drive direction. The robot 100 can also be propelled such that the robot 100 turns in place or turns while moving in the forward drive direction or the rearward drive direction. In addition, the controller 111 can operate the motors 115 to cause the rollers 114a and 114b to rotate, can operate the side brush assembly 122, and can operate the motor of the vacuum system 124 to generate airflow. The controller 111 can execute software stored on the memory 126 to cause the robot 100 to perform various navigational and cleaning behaviors by operating the various motors of the robot 100.

The various sensors of the robot 100 can be used to help the robot navigate and clean within the environment 40. For example, the cliff sensors can detect obstacles such as drop-offs and cliffs below portions of the robot 100 where the cliff sensors are disposed. The cliff sensors can transmit signals to the controller 111 so that the controller 111 can redirect the robot 100 based on signals from the sensors.

Proximity sensors can produce a signal based on a presence or the absence of an object in front of the optical sensor. For example, detectable objects include obstacles such as furniture, walls, persons, and other objects in the environment 40 of the robot 100. The proximity sensors can transmit signals to the controller 111 so that the controller 111 can redirect the robot 100 based on signals from the proximity sensors. In some examples, a bump sensor can be used to detect movement of the bumper 109 along a fore-aft axis of the robot 100. A bump sensor 139 can also be used to detect movement of the bumper 109 along one or more sides of the robot 100 and can optionally detect vertical bumper movement. The bump sensors 139 can transmit signals to the controller 111 so that the controller 111 can redirect the robot 100 based on signals from the bump sensors 139.

The robot 100 can also optionally include one or more dirt sensors 144 connected to the body 102 and in communication with the controller 111. The dirt sensors 144 can be a microphone, piezoelectric sensor, optical sensor, or the like located in or near a flow path of debris, such as near an opening of the cleaning rollers 114 or in one or more ducts within the body 102. This can allow the dirt sensor(s) 144 to detect how much dirt is being ingested by the vacuum assembly 124 (e.g., via the extractor 113) at any time during a cleaning mission. Because the robot 100 can be aware of its location, the robot 100 can keep a log or record of which areas or rooms of the map are dirtier or where more dirt is collected.

The image capture device 140 can be configured to generate a signal based on imagery of the environment 40 of the robot 100 as the robot 100 moves about the floor surface 50. The image capture device 140 can transmit such a signal to the controller 111. The controller 111 can use the signal or signals from the image capture device 140 for various tasks, algorithms, or the like, as discussed in further detail below.

In some examples, the obstacle following sensors can detect detectable objects, including obstacles such as furniture, walls, persons, and other objects in the environment of the robot 100. In some implementations, the sensor system can include an obstacle following sensor along the side surface, and the obstacle following sensor can detect the presence or the absence an object adjacent to the side surface. The one or more obstacle following sensors can also serve as obstacle detection sensors, similar to the proximity sensors described herein.

The robot 100 can also include sensors for tracking a distance travelled by the robot 100. For example, the sensor system can include encoders associated with the motors 116 for the drive wheels 118, and the encoders can track a distance that the robot 100 has travelled. In some implementations, the sensor can include an optical sensor facing downward toward a floor surface. The optical sensor can be positioned to direct light through a bottom surface of the robot 100 toward the floor surface 50. The optical sensor can detect reflections of the light and can detect a distance travelled by the robot 100 based on changes in floor features as the robot 100 travels along the floor surface 50.

The controller 111 can use data collected by the sensors of the sensor system to control navigational behaviors of the robot 100 during the mission. For example, the controller 111 can use the sensor data collected by obstacle detection sensors of the robot 100, (the cliff sensors, the proximity sensors, and the bump sensors) to enable the robot 100 to avoid obstacles within the environment of the robot 100 during the mission.

The sensor data can also be used by the controller 111 for simultaneous localization and mapping (SLAM) techniques in which the controller 111 extracts features of the environment represented by the sensor data and constructs a map of the floor surface 50 of the environment. The sensor data collected by the image capture device 140 can be used for techniques such as vision-based SLAM (VSLAM) in which the controller 111 extracts visual features corresponding to objects in the environment 40 and constructs the map using these visual features. As the controller 111 directs the robot 100 about the floor surface 50 during the mission, the controller 111 can use SLAM techniques to determine a location of the robot 100 within the map by detecting features represented in collected sensor data and comparing the features to previously stored features. The map formed from the sensor data can indicate locations of traversable and nontraversable space within the environment. For example, locations of obstacles can be indicated on the map as nontraversable space, and locations of open floor space can be indicated on the map as traversable space.

The sensor data collected by any of the sensors can be stored in the memory 126. In addition, other data generated for the SLAM techniques, including mapping data forming the map, can be stored in the memory 126. These data produced during the mission can include persistent data that are produced during the mission and that are usable during further missions. In addition to storing the software for causing the robot 100 to perform its behaviors, the memory 126 can store data resulting from processing of the sensor data for access by the controller 111. For example, the map can be a map that is usable and updateable by the controller 111 of the robot 100 from one mission to another mission to navigate the robot 100 about the floor surface 50.

The persistent data, including the persistent map, can help to enable the robot 100 to efficiently clean the floor surface 50. For example, the map can enable the controller 111 to direct the robot 100 toward open floor space and to avoid nontraversable space. In addition, for subsequent missions, the controller 111 can use the map to optimize paths taken during the missions to help plan navigation of the robot 100 through the environment 40.

The controller 111 can also send commands to a motor or actuator 110 (shown in FIG. 2A) that can be connected to the arms 106 and can be located at least partially within the body 102, where the command(s) can drive the arms 106 to move the pad assembly 108 between the stored position (shown in FIGS. 2A and 2D) and the deployed position (shown in FIGS. 2C and 2E). In the deployed position, the pad assembly 108 (the mopping pad 142) can be used to mop a floor surface of any room of the environment 40.

The mopping pad 142 can be a dry pad or a wet pad. Optionally, when the mopping pad 142 is a wet pad, the pump 134 can be operated by the controller 111 to spray or drop fluid (e.g., water or a cleaning solution) onto the floor surface 50 or the mopping pad 142. The wetted mopping pad 142 can then be used by the robot 100 to perform wet mopping operations on the floor surface 50 of the environment 40.

### Network Examples

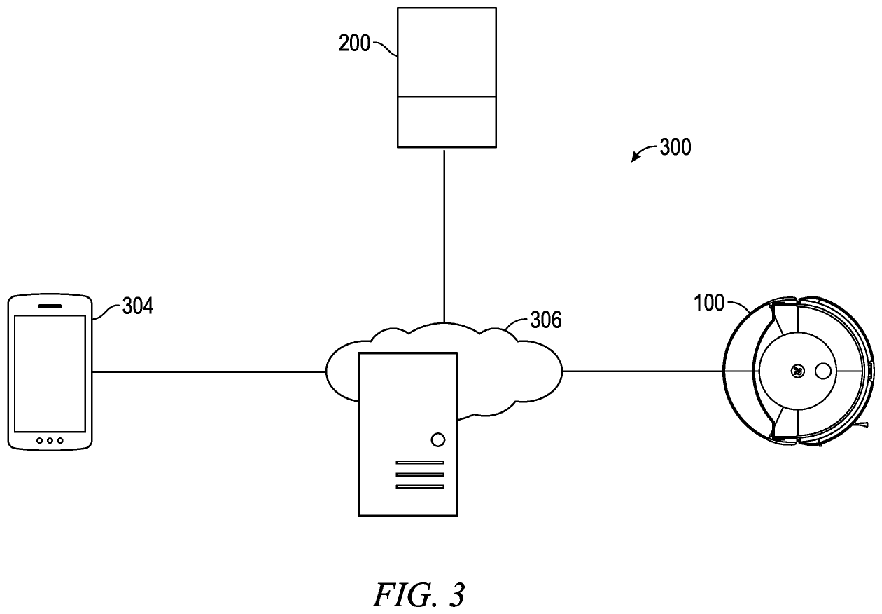

FIG. 3 is a diagram showing a communication network 300 that enables networking between the mobile robot 100 and one or more other devices, a docking station 200 (or any of the docking stations discussed herein), a mobile device 304 (including a controller), a cloud computing system 306 (including a controller), or another autonomous robot separate from the mobile robot 100. Using the communication network 300, the robot 100, the mobile device 304, the docking station 200, and the cloud computing system 306 can communicate with one another to transmit and receive data from one another. In some examples, the robot 100, the docking station 200, or both the robot 100 and the docking station 200 can communicate with the mobile device 304 through the cloud computing system 306. Alternatively, or additionally, the robot 100, the docking station 200, or both the robot 100 and the docking station 200 can communicate directly with the mobile device 304. Various types and combinations of wireless networks (e.g., Bluetooth, radio frequency, optical based, etc.) and network architectures (e.g., wi-fi or mesh networks) can be employed by the communication network 300.

In some examples, the mobile device 304 can be a remote device that can be linked to the cloud computing system 306 and can enable a user to provide inputs. The mobile device 304 can include user input elements such as, for example, one or more of a touchscreen display, buttons, a microphone, a mouse, a keyboard, or other devices that respond to inputs provided by the user. The mobile device 304 can also include immersive media (e.g., virtual reality or augmented reality) with which the user can interact to provide input. The mobile device 304, in these examples, can be a virtual reality headset or a head-mounted display.

The user can provide inputs corresponding to commands for the mobile robot 100. In such cases, the mobile device 304 can transmit a signal to the cloud computing system 306 to cause the cloud computing system 306 to transmit a command signal to the mobile robot 100. In some implementations, the mobile device 304 can present augmented reality images. In some implementations, the mobile device 304 can be a smart phone, a laptop computer, a tablet computing device, or other mobile device.

In some examples, the communication network 300 can include additional nodes. For example, nodes of the communication network 300 can include additional robots. Also, nodes of the communication network 300 can include network-connected devices that can generate information about the environment 40. Such a network-connected device can include one or more sensors, such as an acoustic sensor, an image capture system, or other sensor generating signals, to detect characteristics of the environment 40 from which features can be extracted. Network-connected devices can also include home cameras, smart sensors, or the like.

In the communication network 300, the wireless links can utilize various communication schemes, protocols, etc., such as, for example, Bluetooth classes, Wi-Fi, Bluetooth-low-energy, also known as BLE, 802.15.4, Worldwide Interoperability for Microwave Access (WiMAX), an infrared channel, satellite band, or the like. In some examples, wireless links can include any cellular network standards used to communicate among mobile devices, including, but not limited to, standards that qualify as 1G, 2G, 3G, 4G, 5G, or the like. The network standards, if utilized, qualify as, for example, one or more generations of mobile telecommunication standards by fulfilling a specification or standards such as the specifications maintained by International Telecommunication Union. For example, the 4G standards can correspond to the International Mobile Telecommunications Advanced (IMT-Advanced) specification. Examples of cellular network standards include AMPS, GSM, GPRS, UMTS, LTE, LTE Advanced, Mobile WiMAX, and WiMAX-Advanced. Cellular network standards can use various channel access methods, e.g., FDMA, TDMA, CDMA, or SDMA.

### Mopping Examples

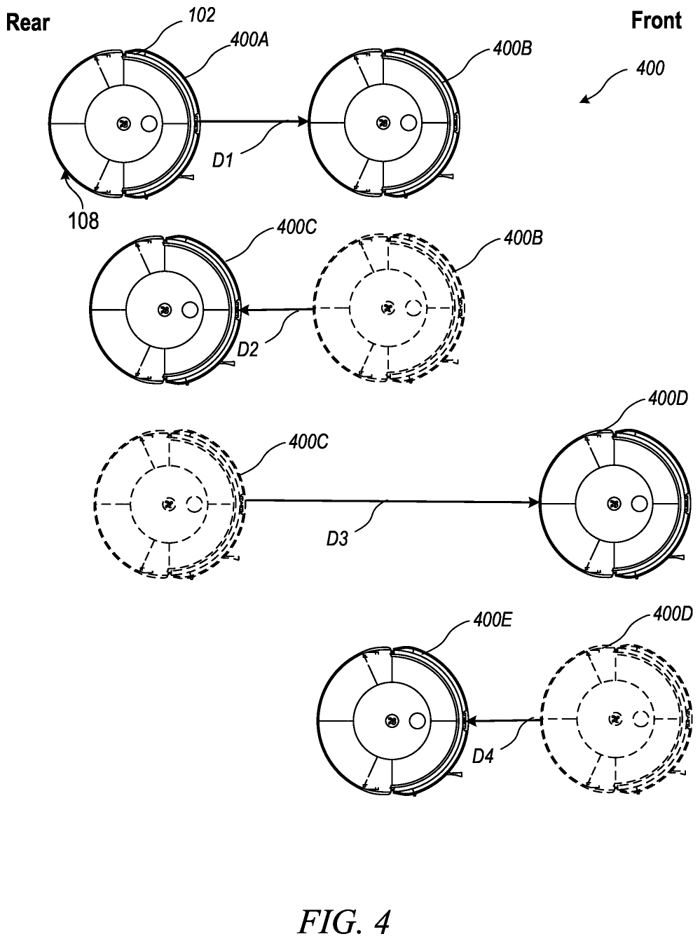

FIG. 4 illustrates a schematic of a movement path 400 of the mobile cleaning robot 100 through a portion of an environment. The schematic can illustrate, by way of example, a path or paths that can be selected and controlled by a controller (e.g., the controller 111) for the robot 100 to travel within the environment 40 to improve a cleaning or mopping efficiency of the robot 100 during one or more cleaning or mopping missions or operations. FIG. 4 also shows orientation indicators Front and Rear

For example, the pad assembly 108 can be moved by the controller 111 (e.g., via the actuator 110) to the cleaning position under the body 102 of the robot 100 such that the pad assembly 108 engages the flooring surface. Once the pad assembly 108 is engaged with the flooring surface, the controller 111 can operate at least one of the drive wheels 118 to move the robot 100 (e.g., the body 102 and the pad assembly 108) forward along a cleaning rank relative to the flooring surface a first time while the cleaning pad assembly 108 (e.g., the mopping pad 142) is engaged with the flooring surface, such as by moving from a position 400A to a position 400B by a distance D1.

After moving forward, the controller 111 can operate at least one of the drive wheels 118 to move the robot 100 (e.g., the body 102 and the pad assembly 108) rearward relative to the flooring surface along the cleaning rank while the mopping pad 142 is engaged with the flooring surface, such as by moving from a position 400B to a position 400C by a distance D2. The positions (e.g., 400A-400E) of the robot 100 can be along or within a common cleaning rank even though the positions 400 of the robot 100 are shown in FIG. 4 as not being in alignment.

After moving rearward, the controller 111 can operate at least one of the drive wheels 118 to move the robot 100 (e.g., the body 102 and the pad assembly 108) forward, such as a second time, relative to the flooring surface along the cleaning rank while the mopping pad 142 is engaged with the flooring surface, such as by moving from a position 400C to a position 400D by a distance D3. After moving forward, the controller 111 can operate at least one of the drive wheels 118 to move the robot 100 (e.g., the body 102 and the pad assembly 108) rearward relative to the flooring surface along the cleaning rank while the mopping pad 142 is engaged with the flooring surface, such as by moving from a position 400D to a position 400E by a distance D4. Optionally, the distance D4 can be the same as the distance D2. That is, the pattern of movement can repeat such that the robot 100 moves forward by the distance D3, moves rearward by the distance D2 (or D4), then moves forward again by the distance D3, and so on.

Such a movement pattern can be repeated following completion of the opening movement sequence where the robot 100 moves by only a distance of D1, which can be smaller than the distance D3. That is, the distance D3 can be the common or repeated distance of forward movement of the robot 100 whereas the distance D1 can be an opening distance for movement of the robot 100 along the cleaning rank, e.g., following a turn, such as to allow the first movement backwards to cover the initial distance D1. For example, when the robot 100 engages a wall or otherwise reaches the end of a rank and makes a turn, the robot 100 can, optionally, first move forward by the distance D1, then rearward by the distance D2, then forward by the distance D3, before repeating the distance D2 rearward.

The third distance D3 can be greater than the first distance D1 and the second distance D2. The second distance D2 can be smaller than the first distance D1 or the third distance D3. In some examples, the third distance D3 can be about 1.5 times a diameter of the mobile cleaning robot. The diameter of the robot can be between 30 centimeters and 40 centimeters, such as 32, 33, 34, 45, 56, or 37 centimeters, or the like. In some examples, the second distance D2 can a multiple of 0.77 diameters of the mobile cleaning robot. In some examples, the first distance D1 can be slightly larger than the second distance D2, such as larger than the distance D2 by between a multiple of 0.003 diameters and 0.2 diameters, such as a multiple between 0.005 diameters and 0.010 diameters, e.g., 0.005 diameters, 0.006 diameters, 0.007 diameters, 0.008 diameters, 0.009 diameters, or the like.

During movement of the robot 100 along the cleaning rank, the robot 100 can dispense or spray cleaning fluid onto the pad assembly 108 or onto the flooring surface (e.g., the floor surface 50). Dispensing or spraying can be controlled by the controller 111 to be performed during forward movements of the robot 100, such as following forward movement of the robot 100 by a relatively small distance, such as between a multiple of 0.005 diameters and 0.010 diameters, e.g., 0.005 diameters, 0.006 diameters, 0.007 diameters, 0.008 diameters, 0.009 diameters, or the like. Dispensing or spraying can continue for a portion of the forward movement, such that spraying can be interrupted by the controller 111 following forward movement of between a multiple of the diameter of 0.3 diameters and 1 diameter, such as 0.3 diameters, 0.4 diameters, 0.5 diameters, 0.6 diameters, 0.7 diameters, 0.8 diameters, 0.9 diameters, or the like. Optionally, a spray distance can be less than the first distance D1, the second distance D2, or the third distance D3. Any of the routines or movement patterns discussed above or below can include spraying of fluid in any of the manners described herein.

Forward movement of the robot 100 can be at a speed of between 100 millimeters per second (mm/s) and 500 mm/s, such as 100 mm/s, 200 mm/s, 300 mm/s, 400 mm/s, 500 mm/s, or the like. Rearward speed of the robot 100 can be similar to the forward speed or can be slower. Optionally, rearward robot speed can be about half of the forward robot speed. Optionally, forward movement of the robot 100 during the routine described above can be interrupted due to obstacle or wall detection during forward movement. In such a case, when an obstacle, wall, or the like is detected, forward movement speed of the robot 100 can be reduced by half until the obstacle is encountered by the robot 100 where the robot 100 can make a turn to move to the next or adjacent cleaning rank (or to another portion of the environment).

Optionally, during the sequence(s) discussed above, the robot 100 (e.g., the controller 111) can continue to perform other algorithms such as SLAM, obstacle detection or avoidance, cliff detection, slip detection, wheel drop, ride-up, or the like. When one or more conditions are detected that are determined by the controller 111 to be hazardous, the controller 111 can stop the mopping or scrubbing sequence, perform one or more steps or maneuvers to avoid the hazard, and then continue performing the mopping sequence or algorithm discussed below. A similar process can be used in any of the mopping sequences discussed above or below.

Using one or more of the above sequences can allow the robot 100 to perform a mopping pattern during a cleaning mission that can increase cleaning or mopping efficiency or effectiveness, such as by engaging or cleaning the same portion of a flooring surface multiple times during a single pass of a cleaning rank.

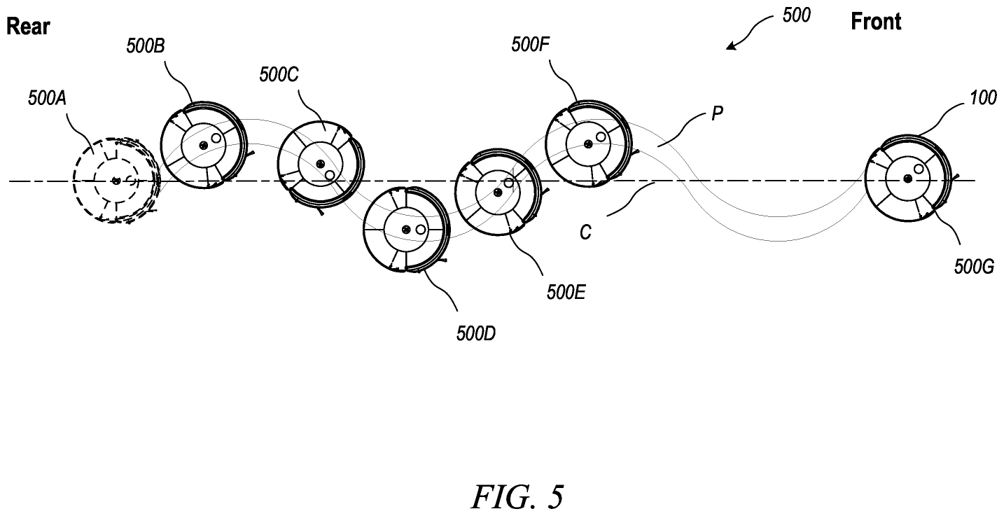

FIG. 5 illustrates a schematic of a movement path 500 of the mobile cleaning robot 100 through a portion of an environment. The schematic can illustrate, by way of example, a path or paths that can be selected and controlled by a controller (e.g., the controller 111) for the robot 100 to travel within the environment 40 to improve a cleaning or mopping efficiency of the robot 100 during one or more cleaning or mopping missions or operations. FIG. 5 also shows orientation indicators Front and Rear

For example, the pad assembly can be moved by the controller 111 to the cleaning position under the body of the robot 100 such that the pad assembly 108 (e.g., the mopping pad 142) engages the flooring surface. Once the mopping pad 142 is engaged with the flooring surface, the controller 111 can operate at least one of the drive wheels 118 to move the robot 100 (e.g., the body 102 and the pad assembly 108) along a cleaning rank at least partially forward relative to the flooring surface During forward movement of the 500. For example, the controller 111 can operate a first wheel of the drive wheels 118 of the mobile cleaning robot 100 at a first speed and can operate a second wheel of the drive wheels 118 of the mobile cleaning robot 100 at a second speed that is lower than the first speed to move the mobile cleaning robot forward and laterally at least partially to a first side of a centerline C of a cleaning rank, such as moving the robot 100 from a position 500A to a position 500B. Such an operation can move the robot 100 to be partially or entirely offset (e.g., laterally to the left) of the centerline C.

Once the robot 100 reaches a desired lateral offset, the controller 111 can control the drive wheels 118 to move back toward the centerline. For example, the controller 111 can operate the second wheel of the mobile cleaning robot 100 at the first speed and can operate the first wheel of the mobile cleaning robot 100 at the second speed to move the mobile cleaning robot forward, to move the mobile cleaning robot laterally toward the centerline, and to move laterally at least partially to a second side of the centerline. For example, the controller 111 can operate the drive wheels 118 to move the robot 100 from the position 500B laterally offset from the centerline (e.g., to the left) to a position 500C close to the centerline C, to a position 500D where the robot 100 crosses or has crossed the centerline C to be laterally offset (e.g., to the right) of the centerline C.

Once the robot 100 reaches a desired lateral offset, the controller 111 can control the drive wheels 118 to move back toward the centerline. For example, the controller 111 can operate the first wheel at the first speed and operate the second wheel at the second speed to move the mobile cleaning robot 100 forward to cross the centerline C, to move the mobile cleaning robot 100 laterally toward the centerline C, and to move laterally at least partially to the first side of the centerline C. For example, the controller 111 can operate the drive wheels 118 to move the robot 100 from the position 500D laterally offset from the centerline (e.g., to the right) to a position 500E close to the centerline C, to a position 500F where the robot 100 crosses or has crossed the centerline C to be laterally offset (e.g., to the left) of the centerline C.

The controller 111 can continue to control operation of the robot 100 such that the robot 100 moves forward and back-and-forth laterally along the centerline C until the robot 100 reaches the end of the cleaning rank, at which point the robot 100 can turn around and perform the same cleaning pattern (e.g., in the opposite direction) along a second cleaning rank. The controller 111 can control movement of the robot 100 such that the second cleaning rank can be adjacent to the first cleaning rank or can be overlapping with the first cleaning rank. The controller 111 can control movement of the robot 100 that the path P of the cleaning ranks are parallel or such that the path P of the cleaning ranks overlap or cross. In some examples, the path P can be sinusoidal about the centerline C.

In some examples, the first speed can be between 50 mm/s and 500 mm/s and the second speed can be zero such that the robot 100 makes relatively tight turns. Optionally, the controller 111 can operate one of the drive wheels 118 to rotate backward while the other drive wheel moves forward, such as to make an even tighter turn. In some examples, the first speed can be between 100 mm/s and 300 mm/s and the second speed can be between 25 mm/s and 100 mm/s such that the robot 100 makes relatively looser or wider turns. The controller 111 can also optionally make the second speed zero for a brief period of time (e.g., half a second or a second) for one wheel while maintaining a speed of the other wheel to cause the turn.

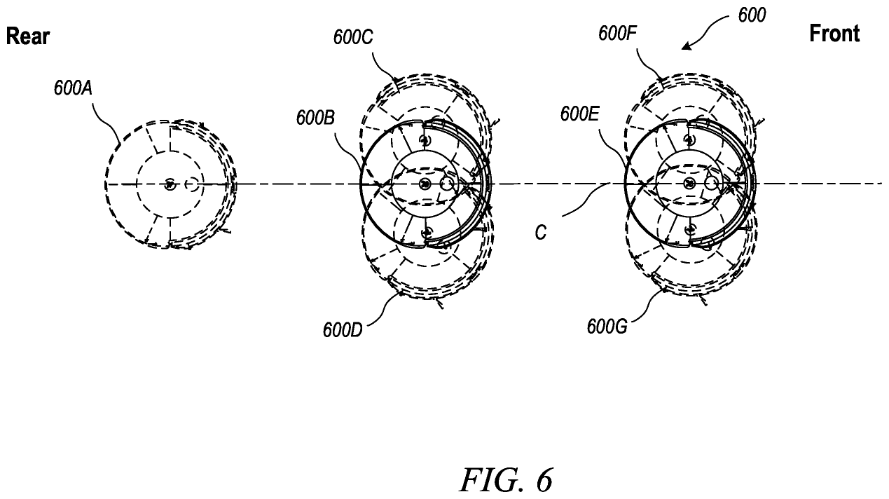

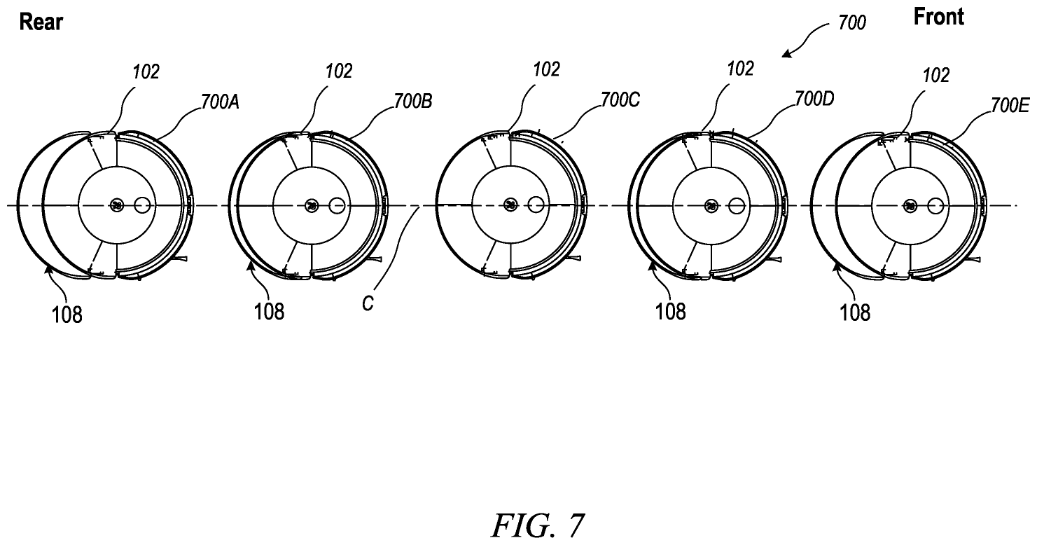

FIG. 6 illustrates a schematic of a movement path 600 of the mobile cleaning robot 100 through a portion of an environment. The schematic can illustrate, by way of example, a path or paths that can be selected and controlled by a controller (e.g., the controller 111) for the robot 100 to travel within the environment 40 to improve a cleaning or mopping efficiency of the robot 100 during one or more cleaning or mopping missions or operations. FIG. 6 also shows orientation indicators Front and Rear

For example, the pad assembly can be moved by the controller 111 to the cleaning position under the body of the robot 100 such that the pad assembly 108 (e.g., the mopping pad 142) engages the flooring surface. Once the mopping pad 142 is engaged with the flooring surface, the controller 111 can operate at least one of the drive wheels 118 to move the robot 100 (e.g., the body 102 and the pad assembly 108) along a cleaning rank at least partially forward relative to the flooring surface during forward movement of the robot 100. When the robot 100 reaches the next location, such as by moving from a location 600A to a location 600B, the controller 111 can operate a first wheel of the drive wheels 118 of the mobile cleaning robot 100 at a first speed and can operate a second wheel of the drive wheels 118 of the mobile cleaning robot 100 at a second speed that is lower than the first speed to rotate the mobile cleaning robot at least partially to a first side of a centerline C of a cleaning rank, such as moving the robot 100 from the position 600B to a position 600C. Such an operation can move the robot 100 to be partially or entirely offset (e.g., laterally to the left) of the centerline C.

The controller 111 can then operate the first drive wheel at the second spend and the second drive wheel at the first speed to rotate the mobile cleaning robot at least partially to a second side of a centerline C of a cleaning rank, such as moving the robot 100 from the position 600C to a position 600D. The controller 111 can then operate the drive wheels 118 to rotate the robot 100 back to the position 600B and the controller 111 can operate the drive wheels 118 to move forward along the centerline C to the position 600E. At any position along the centerline C. the controller 111 can cause the robot 100 to rotate in place, such as the positions 600E, 600F, and 600G.

Such a pattern of movement can be repeated by the robot 100 until a cleaning rank is complete. In this way, the controller 111 can control the robot 100 (and the pad assembly 108) to rotate in place, or nearly in place, such that the robot 100 performs cleaning or scrubbing along a cleaning rank that is wider than a diameter of the robot. Though distances between the positions 600A, 600B, and 600E are shown as being spaced apart, the distances can be relatively close together, such as within one diameter of the robot 100, allowing the robot 100 to clean along an entirety (or a majority or a large portion) of a cleaning rank that is wider than a diameter of the robot 100. Distances between the positions 600A, 600B, and 600E can be other lengths or multiples of the diameter such as 1 diameter, 1.25 diameters, 1.5 diameters, 1.75 diameters, 2 diameters, 3 diameters, or the like.

Also, though the robot 100 is shown as rotating or moving laterally relative to its centerline as it rotates, the robot 100 can rotate in place (e.g., rotate in its position 600B) such that the robot 100 rotates about its center but does not move laterally along its cleaning rank, or such that the robot 100 does not move laterally beyond one diameter of the robot 100. That is, the robot 100 can rotate between 5 degrees and 175 degrees to one side (e.g., similar to the rotational position 600C) and can return to its forward facing position 600B before rotating between 5 degrees and 175 degrees to the other side (e.g., similar to the rotational position 600D) before returning again to its forward facing position 600B and moving forward.

In some examples, the first speed can be in a first rotational direction and the second speed can be in a second rotational direction opposite the first rotational direction. For example, to move from the position 600B to the position 600C, the first wheel can be moved at a speed of 200 mm/s and the second wheel can be moved at a speed of −200 mm/s to cause the robot 100 to at least partially rotate (and to minimize forward or rearward advancement of) the robot. Then, to move from the position 600C to 600D, the first wheel can be moved at a speed of −200 mm/s and the second wheel can be moved at a speed of 200 mm/s to at least partially rotate (and to minimize forward or rearward advancement of) the robot. In some examples, the wheels can operate at higher speeds or lower speeds and can still be symmetric or offsetting (e.g., −100 mm/s and 100 mm/s) or can operate at asymmetric speeds to achieve different rotational patterns, such as by operating the first wheel at 200 mm/s and operating the second wheel at −250 mm/s such as to cause the robot 100 to move slightly rearward when rotating.

FIG. 7 illustrates a schematic of a movement path 700 of the mobile cleaning robot 100 through a portion of an environment. The schematic can illustrate, by way of example, a path or paths that can be selected and controlled by a controller (e.g., the controller 111) for the robot 100 to travel within the environment 40 to improve a cleaning or mopping efficiency of the robot 100 during one or more cleaning or mopping missions or operations. FIG. 7 also shows orientation indicators Front and Rear

For example, the pad assembly 108 can be moved by the controller 111 to the cleaning position under the body 102 of the robot 100 such that the pad assembly 108 engages the flooring surface. Once the pad assembly 108 (e.g., the mopping pad 142) is engaged with the flooring surface, the controller 111 can operate at least one of the drive wheels 118 to move the robot 100 (e.g., the body 102 and the pad assembly 108) along a cleaning rank forward relative to the flooring surface a first time along a cleaning rank while the cleaning pad is engaged with the flooring surface, such as by moving from a position 700A to a position 700B. During such forward movement, the controller 111 can operate an actuator (e.g., the actuator 110) to move the pad assembly 108 with respect to the body 102 and at least partially underneath or below the body 102 from an extended position shown in position 700A to a partially retracted position shown in position 700B.

As the controller 111 continues to move the robot 100 forward, such as from the position 700B to the position 700C, the controller 111 can operate the actuator 110 to further move the pad assembly 108, such as to a fully retracted position of the position 700C. Then, as the controller 111 continues to move the robot 100 forward, such as from the position 700C to the position 700D, the controller 111 can operate the actuator 110 to further move the pad assembly 108, such as to a partially extended position of the position 700D to a fully extended position of the position 700E.

As the controller 111 moves the robot 100 forward (but also optionally backwards or to the side), the controller 111 can operate the actuator 110 to move the pad assembly 108 back and forth (e.g., repeatedly) relative to the body 102. In other words, the controller 111 can move the pad assembly 108 to create a scrubbing action of the mopping pad 142 as the robot 100 is moved within or throughout an environment to help improve cleaning efficiency or effectiveness. The actuator 110 can be the same motor or actuator and the arms 106 can be the same arms that move the pad assembly 108 between the stored position and the cleaning or deployed position, helping to reduce mass and cost of the robot 100.

Though the movement patterns discussed above in FIGS. 4-7 are discussed as being independent movement patterns, one or more of the movements or patterns can be combined. For example, the back and forth scrubbing of the pad assembly 108 FIG. 7 can be combined with any of the movement patterns of FIG. 4-6. Or, the back and forth movement of the robot 100 of FIG. 4 can be used in any of the movement patterns of FIGS. 5-7 such that the robot can retrace any movement pattern it performs. Any combination of discussed movement patterns can be used by the robot 100 or the controller 111.

Optionally, the controller 111 can be configured to perform one or more of the cleaning patterns discussed above based on instructions received from another device, such as from the mobile device 304 or the cloud computing system 306. That is, a user can use the mobile device 304 to select a desired movement pattern to perform during mopping operations. Optionally, the user can select a movement pattern for a specific room or area of the environment, where the pattern selected for individual rooms can vary therebetween.

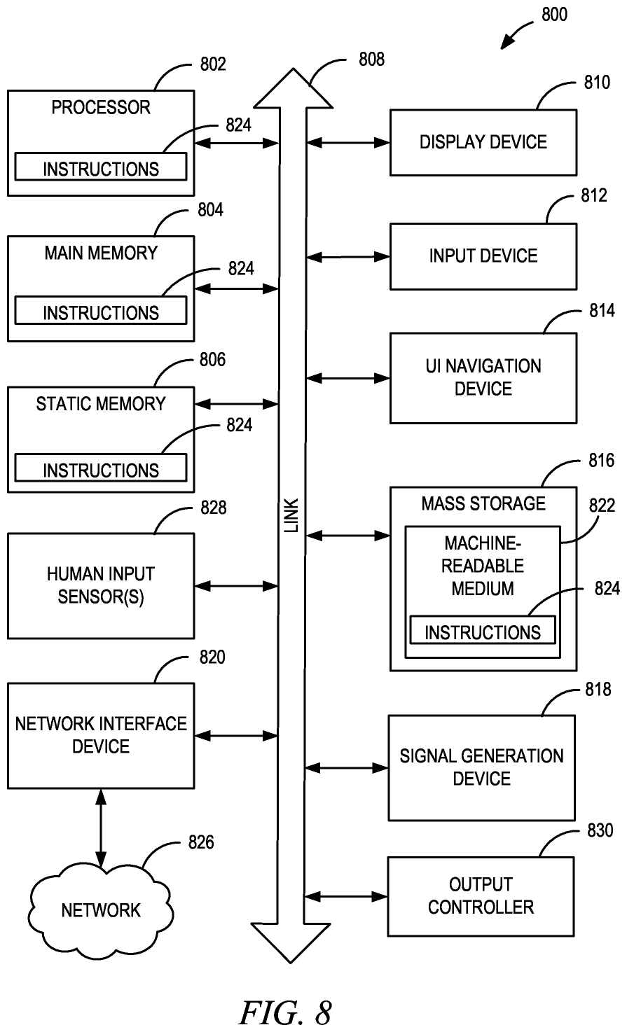

FIG. 8 illustrates a block diagram of an example machine 800 upon which any one or more of the techniques (e.g., methodologies) discussed herein may perform. Examples, as described herein, may include, or may operate by, logic or a number of components, or mechanisms in the machine 800. Circuitry (e.g., processing circuitry) is a collection of circuits implemented in tangible entities of the machine 800 that include hardware (e.g., simple circuits, gates, logic, etc.). Circuitry membership may be flexible over time. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a machine readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the machine 800 follow.

In alternative embodiments, the machine 800 may operate as a standalone device or may be connected (e.g., networked) to other machines. In a networked deployment, the machine 800 may operate in the capacity of a server machine, a client machine, or both in server-client network environments. In an example, the machine 800 may act as a peer machine in peer-to-peer (P2P) (or other distributed) network environment. The machine 800 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

The machine (e.g., computer system) 800 may include a hardware processor 802 (e.g., a central processing unit (CPU), a graphics processing unit (GPU), a hardware processor core, or any combination thereof), a main memory 804, a static memory (e.g., memory or storage for firmware, microcode, a basic-input-output (BIOS), unified extensible firmware interface (UEFI), etc.) 806, and mass storage 808 (e.g., hard drive, tape drive, flash storage, or other block devices) some or all of which may communicate with each other via an interlink (e.g., bus) 830. The machine 800 may further include a display unit 810, an alphanumeric input device 812 (e.g., a keyboard), and a user interface (UI) navigation device 814 (e.g., a mouse). In an example, the display unit 810, input device 812 and UI navigation device 814 may be a touch screen display. The machine 800 may additionally include a storage device (e.g., drive unit) 808, a signal generation device 818 (e.g., a speaker), a network interface device 820, and one or more sensors 816, such as a global positioning system (GPS) sensor, compass, accelerometer, or other sensor. The machine 800 may include an output controller 828, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the processor 802, the main memory 804, the static memory 806, or the mass storage 808 may be, or include, a machine readable medium 822 on which is stored one or more sets of data structures or instructions 824 (e.g., software) embodying or utilized by any one or more of the techniques or functions described herein. The instructions 824 may also reside, completely or at least partially, within any of registers of the processor 802, the main memory 804, the static memory 806, or the mass storage 808 during execution thereof by the machine 800. In an example, one or any combination of the hardware processor 802, the main memory 804, the static memory 806, or the mass storage 808 may constitute the machine readable media 822. While the machine readable medium 822 is illustrated as a single medium, the term “machine readable medium” may include a single medium or multiple media (e.g., a centralized or distributed database, and/or associated caches and servers) configured to store the one or more instructions 824.

The term “machine readable medium” may include any medium that is capable of storing, encoding, or carrying instructions for execution by the machine 800 and that cause the machine 800 to perform any one or more of the techniques of the present disclosure, or that is capable of storing, encoding or carrying data structures used by or associated with such instructions. Non-limiting machine readable medium examples may include solid-state memories, optical media, magnetic media, and signals (e.g., radio frequency signals, other photon based signals, sound signals, etc.). In an example, a non-transitory machine readable medium comprises a machine readable medium with a plurality of particles having invariant (e.g., rest) mass, and thus are compositions of matter. Accordingly, non-transitory machine-readable media are machine readable media that do not include transitory propagating signals. Specific examples of non-transitory machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 824 may be further transmitted or received over a communications network 826 using a transmission medium via the network interface device 820 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 820 may include one or more physical jacks (e.g., Ethernet, coaxial, or phone jacks) or one or more antennas to connect to the communications network 826. In an example, the network interface device 820 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 800, and includes digital or analog communications signals or other intangible medium to facilitate communication of such software. A transmission medium is a machine readable medium.

### NOTES AND EXAMPLES

The following, non-limiting examples, detail certain aspects of the present subject matter to solve the challenges and provide the benefits discussed herein, among others.

Example 1 is a method of operating a mobile cleaning robot, the method comprising: engaging a flooring surface of an environment with a cleaning pad of the mobile cleaning robot; operating at least one wheel of the mobile cleaning robot to move the mobile cleaning robot forward relative to the flooring surface a first time along a cleaning rank while the cleaning pad is engaged with the flooring surface; operating, after moving forward, the at least one wheel of the mobile cleaning robot to move the mobile cleaning robot rearward relative to the flooring surface along the cleaning rank while the cleaning pad is engaged with the flooring surface; and operating, after moving rearward, the at least one wheel of the mobile cleaning robot to move the mobile cleaning robot forward a second time relative to the flooring surface along the cleaning rank while the cleaning pad is engaged with the flooring surface.

In Example 2, the subject matter of Example 1 optionally includes wherein the mobile cleaning robot moves forward a first distance when the mobile cleaning robot moves forward the first time, wherein the mobile cleaning robot moves rearward a second distance when the mobile cleaning robot moves rearward, wherein the mobile cleaning robot moves forward a third distance when the mobile cleaning robot moves forward the second time, and wherein the third distance is greater than the first distance and the second distance.

In Example 3, the subject matter of Example 2 optionally includes wherein second distance is smaller than the first distance and the third distance.

In Example 4, the subject matter of Example 3 optionally includes times a diameter of the mobile cleaning robot.

In Example 5, the subject matter of Example 4 optionally includes times a diameter of the mobile cleaning robot.

In Example 6, the subject matter of any one or more of Examples 3-5 optionally include spraying liquid on the flooring surface during moving forward along the cleaning rank.

In Example 7, the subject matter of Example 6 optionally includes interrupting spraying liquid during moving forward and before moving backward.

In Example 8, the subject matter of any one or more of Examples 6-7 optionally include wherein a spray distance is less than first distance, the second distance, and the third distance.

In Example 9, the subject matter of any one or more of Examples 1-8 optionally include moving the cleaning pad relative to a body of the mobile cleaning robot using a pad drive system of the mobile cleaning robot at least one of when the mobile cleaning robot moves forward the first time, moves backward, and moves forward the second time.

Example 10 is a method of operating a mobile cleaning robot, the method comprising: engaging a flooring surface of an environment with a cleaning pad of the mobile cleaning robot; operating at first wheel of the mobile cleaning robot at a first speed and operating a second wheel of the mobile cleaning robot at a second speed that is lower than the first speed to move the mobile cleaning robot forward and laterally to a first side of a centerline of a cleaning rank; operating the second wheel of the mobile cleaning robot at the first speed and operating the first wheel of the mobile cleaning robot at the second speed to move the mobile cleaning robot forward, to move the mobile cleaning robot laterally toward the centerline, and to move laterally to a second side of the centerline.

In Example 11, the subject matter of Example 10 optionally includes operating the first wheel at the first speed and operating the second wheel at the second speed to move the mobile cleaning robot forward to cross the centerline, to move the mobile cleaning robot laterally toward the centerline, and to move laterally to the first side of the centerline.

In Example 12, the subject matter of Example 11 optionally includes wherein the mobile cleaning robot moves sinusoidally about the centerline.

In Example 13, the subject matter of any one or more of Examples 10-12 optionally include wherein the first speed is in a first rotational direction and wherein the second speed is zero.

In Example 14, the subject matter of any one or more of Examples 10-13 optionally include wherein the first speed is in a first rotational direction and wherein the second speed is in a second rotational direction opposite the first rotational direction.

Example 15 is a non-transitory machine-readable medium including instructions, for operating a mobile cleaning robot, which when executed by a machine, cause the machine to: operate an actuator connected to a cleaning pad assembly to move a cleaning pad of the cleaning pad assembly from a stored position at least partially above a body of mobile cleaning robot to a deployed position at least partially below the body; engage a flooring surface of an environment with the cleaning pad; operate one or more of a pair of drive wheels of the mobile cleaning robot to move the mobile cleaning robot along a cleaning rank; operate the actuator to move the cleaning pad forward and backward when the cleaning pad is at least partially underneath the body to scrub the flooring surface as the mobile cleaning robot is moving along the cleaning rank.

In Example 16, the subject matter of Example 15 optionally includes wherein the actuator is operated to move the cleaning pad forward and backward repeatedly as the mobile cleaning robot moves along the cleaning rank.

In Example 17, the subject matter of any one or more of Examples 15-16 optionally include the instructions to further cause the machine to: engage a flooring surface of an environment with a cleaning pad of the mobile cleaning robot; operate at least one wheel of the mobile cleaning robot to move the mobile cleaning robot forward relative to the flooring surface a first time along a cleaning rank while the cleaning pad is engaged with the flooring surface; operate, after moving forward, the at least one wheel of the mobile cleaning robot to move the mobile cleaning robot rearward relative to the flooring surface along the cleaning rank while the cleaning pad is engaged with the flooring surface; and operate, after moving rearward, the at least one wheel of the mobile cleaning robot to move the mobile cleaning robot forward a second time relative to the flooring surface along the cleaning rank while the cleaning pad is engaged with the flooring surface.

In Example 18, the subject matter of Example 17 optionally includes wherein the mobile cleaning robot moves forward a first distance when the mobile cleaning robot moves forward the first time, wherein the mobile cleaning robot moves rearward a second distance when the mobile cleaning robot moves rearward, wherein the mobile cleaning robot moves forward a third distance when the mobile cleaning robot moves forward the second time, and wherein the third distance is greater than the first distance and the second distance.

In Example 19, the subject matter of Example 18 optionally includes wherein second distance is smaller than the first distance and the third distance.

In Example 20, the subject matter of Example 19 optionally includes times a diameter of the mobile cleaning robot.

Example 21 is an apparatus comprising means to implement of any of Examples 1-20.

Example 22 is a system to implement of any of Examples 1-20.

Example 23 is a method to implement of any of Examples 1-20.

In Example 24, the apparatuses, systems, or methods of any one or any combination of Examples 1-25 can optionally be configured such that all elements or options recited are available to use or select from.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim.

The above description is intended to be illustrative, and not restrictive. For example, the above-described examples (or one or more aspects thereof) can be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features can be grouped together to streamline the disclosure. This should not be interpreted as intending that an unclaimed disclosed feature is essential to any claim. Rather, inventive subject matter can lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A method of operating a mobile cleaning robot, the method comprising:
engaging a flooring surface of an environment with a cleaning pad of the mobile cleaning robot;
operating at least one wheel of the mobile cleaning robot to move the mobile cleaning robot forward relative to the flooring surface a first time along a cleaning rank while the cleaning pad is engaged with the flooring surface;
operating, after moving forward, the at least one wheel of the mobile cleaning robot to move the mobile cleaning robot rearward relative to the flooring surface along the cleaning rank while the cleaning pad is engaged with the flooring surface; and
operating, after moving rearward, the at least one wheel of the mobile cleaning robot to move the mobile cleaning robot forward a second time relative to the flooring surface along the cleaning rank while the cleaning pad is engaged with the flooring surface.

2. The method of claim 1, wherein the mobile cleaning robot moves forward a first distance when the mobile cleaning robot moves forward the first time, wherein the mobile cleaning robot moves rearward a second distance when the mobile cleaning robot moves rearward, wherein the mobile cleaning robot moves forward a third distance when the mobile cleaning robot moves forward the second time, and wherein the third distance is greater than the first distance and the second distance.

3. The method of claim 2, wherein second distance is smaller than the first distance and the third distance.

4. The method of claim 3, wherein the third distance is 1.5 times a diameter of the mobile cleaning robot.

5. The method of claim 4, wherein the second distance is 0.77 times a diameter of the mobile cleaning robot.

6. The method of claim 3, further comprising:
spraying liquid on the flooring surface during moving forward along the cleaning rank.

7. The method of claim 6, further comprising:
interrupting spraying liquid during moving forward and before moving backward.

8. The method of claim 6, wherein a spray distance is less than first distance, the second distance, and the third distance.

9. The method of claim 1, further comprising:
moving the cleaning pad relative to a body of the mobile cleaning robot using a pad drive system of the mobile cleaning robot at least one of when the mobile cleaning robot moves forward the first time, moves backward, and moves forward the second time.

10. A method of operating a mobile cleaning robot, the method comprising:
engaging a flooring surface of an environment with a cleaning pad of the mobile cleaning robot;
operating at first wheel of the mobile cleaning robot at a first speed and operating a second wheel of the mobile cleaning robot at a second speed that is lower than the first speed to move the mobile cleaning robot forward and laterally to a first side of a centerline of a cleaning rank;
operating the second wheel of the mobile cleaning robot at the first speed and operating the first wheel of the mobile cleaning robot at the second speed to move the mobile cleaning robot forward, to move the mobile cleaning robot laterally toward the centerline, and to move laterally to a second side of the centerline.

11. The method of claim 10, comprising:
operating the first wheel at the first speed and operating the second wheel at the second speed to move the mobile cleaning robot forward to cross the centerline, to move the mobile cleaning robot laterally toward the centerline, and to move laterally to the first side of the centerline.

12. The method of claim 11, wherein the mobile cleaning robot moves sinusoidally about the centerline.

13. The method of claim 10, wherein the first speed is in a first rotational direction and wherein the second speed is zero.

14. The method of claim 10, wherein the first speed is in a first rotational direction and wherein the second speed is in a second rotational direction opposite the first rotational direction.

15. A non-transitory machine-readable medium including instructions, for operating a mobile cleaning robot, which when executed by a machine, cause the machine to:
operate an actuator connected to a cleaning pad assembly to move a cleaning pad of the cleaning pad assembly from a stored position at least partially above a body of mobile cleaning robot to a deployed position at least partially below the body;
engage a flooring surface of an environment with the cleaning pad;
operate one or more of a pair of drive wheels of the mobile cleaning robot to move the mobile cleaning robot along a cleaning rank;
operate the actuator to move the cleaning pad forward and backward when the cleaning pad is at least partially underneath the body to scrub the flooring surface as the mobile cleaning robot is moving along the cleaning rank.

16. The non-transitory machine-readable medium of claim 15, wherein the actuator is operated to move the cleaning pad forward and backward repeatedly as the mobile cleaning robot moves along the cleaning rank.

17. The non-transitory machine-readable medium of claim 15, the instructions to further cause the machine to:
engage a flooring surface of an environment with a cleaning pad of the mobile cleaning robot;
operate at least one wheel of the mobile cleaning robot to move the mobile cleaning robot forward relative to the flooring surface a first time along a cleaning rank while the cleaning pad is engaged with the flooring surface;
operate, after moving forward, the at least one wheel of the mobile cleaning robot to move the mobile cleaning robot rearward relative to the flooring surface along the cleaning rank while the cleaning pad is engaged with the flooring surface; and
operate, after moving rearward, the at least one wheel of the mobile cleaning robot to move the mobile cleaning robot forward a second time relative to the flooring surface along the cleaning rank while the cleaning pad is engaged with the flooring surface.

18. The non-transitory machine-readable medium of claim 17, wherein the mobile cleaning robot moves forward a first distance when the mobile cleaning robot moves forward the first time, wherein the mobile cleaning robot moves rearward a second distance when the mobile cleaning robot moves rearward, wherein the mobile cleaning robot moves forward a third distance when the mobile cleaning robot moves forward the second time, and wherein the third distance is greater than the first distance and the second distance.

19. The non-transitory machine-readable medium of claim 18, wherein second distance is smaller than the first distance and the third distance.

20. The non-transitory machine-readable medium of claim 19, wherein the third distance is 1.5 times a diameter of the mobile cleaning robot.
